(19) United States
(12) Patent Application Publication
(10) Pub. No.: US 2004/0210497 A1
(43) Pub. Date: Oct. 21, 2004

(54) Expense management system, expenses management apparatus, and expense management method

(75) Inventors: Ayumi Hirayama, Tokyo (JP); Teruyuki Obara, Tokyo (JP)

Correspondence Address: MORRISON & FOERSTER LLP, 1650 TYSONS BOULEVARD, SUITE 300, MCLEAN, VA, 22102, US

(73) Assignee: RICOH COMPANY, LTD., Tokyo (JP)

(21) Appl. No.: 10/797,603

(22) Filed: Mar. 11, 2004

(30) Foreign Application Priority Data
Mar. 12, 2003 (JP) 2003-067158
Mar. 14, 2003 (JP) 2003-070909

(51) Int. Cl. G06F 17/60

(52) U.S. Cl. 705/30

(57) ABSTRACT

An expense management system for enabling auditing of applications while preventing information leakage and realizing efficient management of expenses is provided. The system includes a debit note managing unit, a progress information managing unit, and an attaching unit. The debit note managing unit manages debit note information sent from a firm that is commissioned to handle application of an intellectual property right, the debit note information including expense information pertaining to the application. The progress information managing unit manages progress information pertaining to a progress of the application. The attaching unit attaches the progress information to the debit note information.

### BACKGROUND OF THE INVENTION

1. Field of the Invention

The present invention relates generally to an expense management system, and particularly, to an intellectual property expense management system for managing expense information and progress information pertaining to an application for an intellectual property right such as a right to a patent, for example.

The present invention also relates to an expense management system, apparatus, and method for managing debit information sent from a business partner.

2. Description of the Related Art

Conventionally, a company relies on a number of patent firms to undertake application and various procedures relating to application for a right to intellectual property such as a patent for an invention conceived by a technical staff member. A patent firm arranges an interview with an inventor to produce a patent application, for example, and after filing the application, sends to the company a debit note indicating fees pertaining to the filing of the application in the form of a document or electronic data. The company receiving the debit note in the form of a document or electronic data makes payments for the application fees and other expenses to the patent firm based on this debit note. However, for companies that file a large number of patent applications, managing payment for expenses relating to patent application filing itself can be quite burdensome. Therefore, to improve efficiency in managing payment for expenses, a debit note received in the form of a document is converted into electronic data, and an expense management system is used for managing debit notes in electronic data format as expense information in a database (also referred to as ‘DB’ hereinafter).

For example, in Japanese Laid-Open Patent Publication No. 10-283400, a patent firm services management apparatus implementing a computer that executes a debit program for managing fees pertaining to application, interlocutory proceedings, and registration of industrial property rights is disclosed.

However, most expense management systems according to the conventional art only manage expense items and their corresponding sums as expense information. That is, information relating to the application such as details of the application content (e.g., number of claims, number of lines contained in the application, number of drawings), person in charge of the application at the intellectual property department of the company, progress of the application (e.g., whether an interview has already been conducted) is not managed in the conventional expense management system. Thus, application expense management that is realized by the expense management system according to the conventional art is not suitable for auditing purposes.

Also, in another conventional expense management system, when a debit note containing application information is received, application information that is relevant with respect to the expense management system used at the company has to be extracted each time, thereby imposing a great burden on the information managing staff.

Also, a private line is conventionally used in the communication environment between a company and a patent firm owing to the nature of information being handled. Specifically, when a debit note containing application information is exchanged, for example, it is not practical to use a public network such as the Internet due to risks of information leakage. In turn, when some kind of problem occurs in the private line so that communication cannot be established via this line, the debit note may alternatively be sent by mail, for example. In such case, processing and management of the debit note takes time.

Also, in the field of intellectual property, very complicated administrative processes are required for application procedures, interlocutory procedures, registration procedures, international application procedures of patents, utility models, designs and trademarks, for example. Fees for such procedures are determined based on numerous conditions so that it is difficult to manage the fees manually. For example, in the case of a patent application, fees may be determined based on the number of claims, the number of lines, and the number of drawings, for example. In turn, a management apparatus that manages the fees pertaining to application, interlocutory proceedings, and registration of an intellectual property right using a computer is proposed in the conventional art as is illustrated, for example, in Japanese Laid-Open Patent Publication No. 10-283400.

However, the conventional management apparatus is adapted for the business partner firm side to manage its orders such as patent application orders. Therefore, the conventional management apparatus is not suitable for patent management at the company side especially with respect to expense management.

For example, at the company side, debit notes sent from business partners may be managed and payments may be made based on these debit notes. In such case, when a debit note is issued from a patent firm, for example, the managing staff of the company verifies the accuracy of the debit note before making payment for the fee charged, and when an error is found, a notification is made to the patent firm. Under such circumstances, accurate determination is difficult due to potential errors in the verification and risks of information leakage. As a result, accidents are prone to occur such as needless payment of fees or missing payments, for example.

Also, conventionally a budget is set by the managing staff through estimation based on experience; however, in such case, a budget that is higher than necessary may be set, thereby creating a large difference between the set budget and the actual payment.

### SUMMARY OF THE INVENTION

It is an object of the present invention to provide an intellectual property expense management system for managing debit note information having application information attached thereto and managing common expense information that is shared within a company so that auditing of applications may be performed, and at the same time, information leakage may be prevented and expenses arising within a company may be efficiently managed.

It is another object of the present invention to provide an expense management system, apparatus, and method that realizes accurate management of expenses by verifying the accuracy of a fee being charged by a business partner and/or estimating the expense of an order for which a fee is not yet charged.

According to an aspect of the present invention, an intellectual property expense management system is provided, the system including:

a debit note managing unit that manages debit note information sent from a firm that is commissioned to handle application of an intellectual property right, the debit note information including expense information pertaining to the application;

a progress information managing unit that manages progress information pertaining to a progress of the application; and

an attaching unit that attaches the progress information to the debit note information.

By attaching progress information pertaining to the progress of the application to the debit note information pertaining to the expense of the application, auditing of the application may be performed, and at the same time, information leakage may be prevented and expenses arising within a company may be efficiently managed.

In an embodiment of the present invention, an intellectual property expense management system of the present invention may include an attached information managing unit that manages the attached information including the progress information attached to the debit note information. According to the present embodiment, the attached information including the progress information may be efficiently managed.

In another embodiment of the present invention, an attaching unit may attach the progress information to the debit note information according to a case code for identifying the application that is included in the progress information and the debit note information. According to the present embodiment, progress information may be easily attached to its corresponding debit note information.

In another embodiment, an intellectual property expense management system of the present invention may include:

an expense information generation unit that is adapted to generate common expense information based on the debit note information, the common expense information being shared within a company managing expense information pertaining to a plurality of applications; and

a common expense information managing unit that manages the common expense information generated by the expense generation unit.

According to an embodiment of the present invention, further preventive measures may be taken against information leakage.

In another embodiment of the present invention, an intellectual property expense management system of the present invention may include a progress information updating unit that updates the progress information based on the debit note information. According to the present embodiment, the latest progress information may be managed and auditing of the application may be performed based on the latest progress information.

According to another aspect of the present invention, an information management system is provided, the system including:

a business partner terminal apparatus that sends invoice information and debit note information that is generated based on the invoice information; and

an expense management apparatus that manages the invoice information and the debit note information sent from the business partner terminal apparatus; wherein

the expense management apparatus is adapted to calculate debit information based on the invoice information sent from the business partner terminal apparatus to thereby generate calculated debit information, compare the calculated debit information and the debit note information sent from the business partner terminal apparatus, determine whether the debit note information sent from the business partner terminal apparatus corresponds to the calculated debit information, and send a debit information verification request to the business partner terminal apparatus upon determining that the debit note information from the business partner terminal apparatus does not correspond to the calculated debit information.

By calculating debit information based on invoice information that is sent from a business partner terminal apparatus, and comparing the calculated debit information with debit note information that is sent from the business partner terminal to determine whether the two correspond, the accuracy of the debit note sent from the business partner terminal may be verified. Further, when it is determined that debit note information is not accurate, a debit information verification request may be sent to the business partner terminal apparatus. In this way, accuracy of fees being charged may be checked, and debits and payments may be accurately managed so that errors such as excessive payments or missing payments may be prevented, for example.

Also, in another aspect of the present invention, debit information corresponding to an order for which invoice information is not yet sent from a business partner terminal apparatus may be estimated based on a past record of invoice information sent from the business partner terminal apparatus. Accordingly, even when ordered cases and articles for which fees are not yet charged exist, fees for such cases and articles may be estimated and compiled with due consideration to the nature of the respective cases and articles so that a budget may be easily planned, for example.

### BRIEF DESCRIPTION OF THE DRAWINGS

FIG. 1 is a block diagram illustrating a configuration of an intellectual property expense management system according to a first embodiment of the present invention;

FIG. 2 is a diagram illustrating an example of a debit note that may be on a paper medium or in electronic data format;

FIG. 3 is a table illustrating an example of progress information stored in a progress information database;

FIG. 4 is a table illustrating an example of expense master information stored in an expense master information database;

FIG. 5 is a flowchart illustrating intellectual property expense management operation procedures according to the first embodiment of the present invention;

FIG. 6 is a block diagram illustrating a configuration of an expense management system according to a second embodiment of the present invention;

FIG. 7 is a block diagram illustrating a configuration of a terminal apparatus;

FIG. 8 is a flowchart illustrating an electronic application filing program that is installed in the terminal apparatus;

FIG. 9 is a flowchart illustrating an invoice/debit note issuing program that is installed in the terminal apparatus;

FIG. 10 is a block diagram illustrating a configuration of a management apparatus;

FIG. 11 is a block diagram illustrating a configuration of a communication management server;

FIG. 12 is a block diagram illustrating a configuration of an expense management server;

FIG. 13 is a flowchart illustrating a management program that is executed by the management server;

FIG. 14 is a table illustrating a data configuration of a debit note database;

FIG. 15 is a flowchart illustrating an accuracy determination process that is executed by the management server;

FIG. 16 is a table illustrating a data configuration of a business partner database;

FIG. 17 is a table illustrating a data configuration of a patent common master database; and

FIG. 18 is a flowchart illustrating an estimation process that is executed by the management server.

### DESCRIPTION OF THE PREFERRED EMBODIMENTS

In the following, preferred embodiments of the present invention are described with reference to the accompanying drawings.

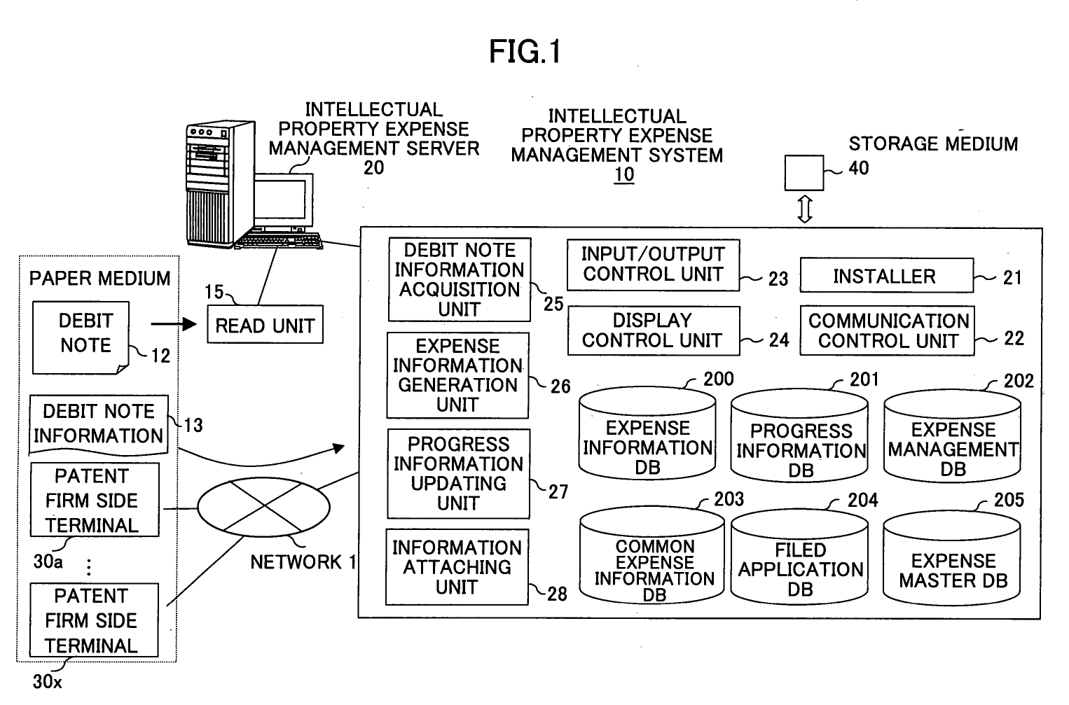

FIG. 1 is a block diagram illustrating a configuration of an intellectual property expense management system according to a first embodiment of the present invention. In FIG. 1, the intellectual property expense management system 10 includes an intellectual property expense management server 20 that is operated within a company and is adapted to manage expense information and progress information relating to application for an intellectual property right such as a patent, patent firm side terminals 30a˜30x that are stationed outside the company at patent firms that are commissioned by the company to undertake various procedures for patent application filing, for example. The intellectual property expense management server 20 and the patent firm side terminals 30a˜30x are connected via a network 1 that may correspond to a public network such as the Internet or a private line.

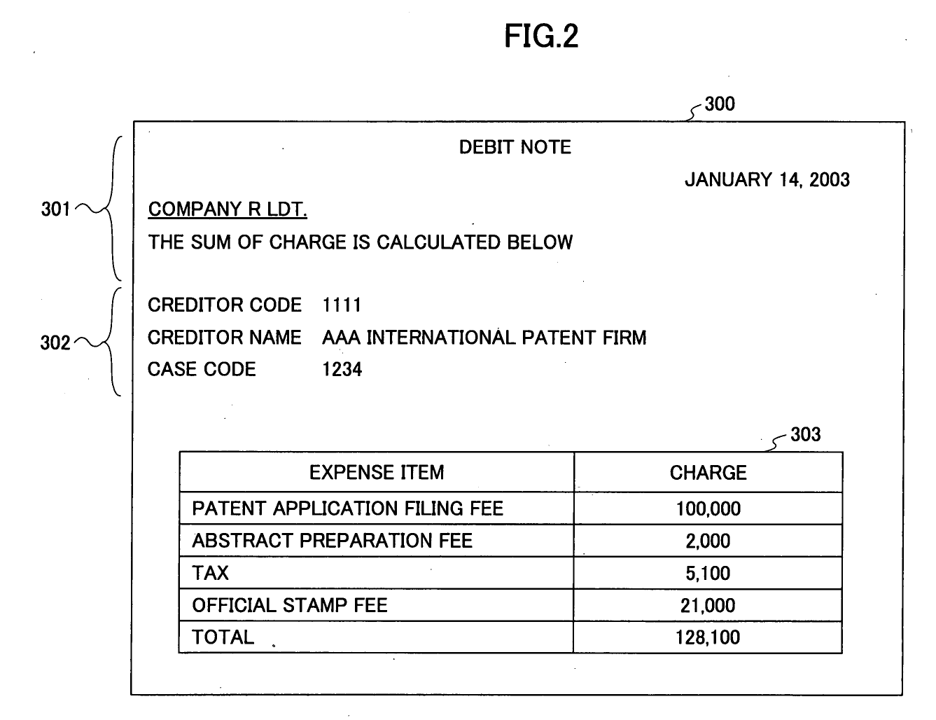

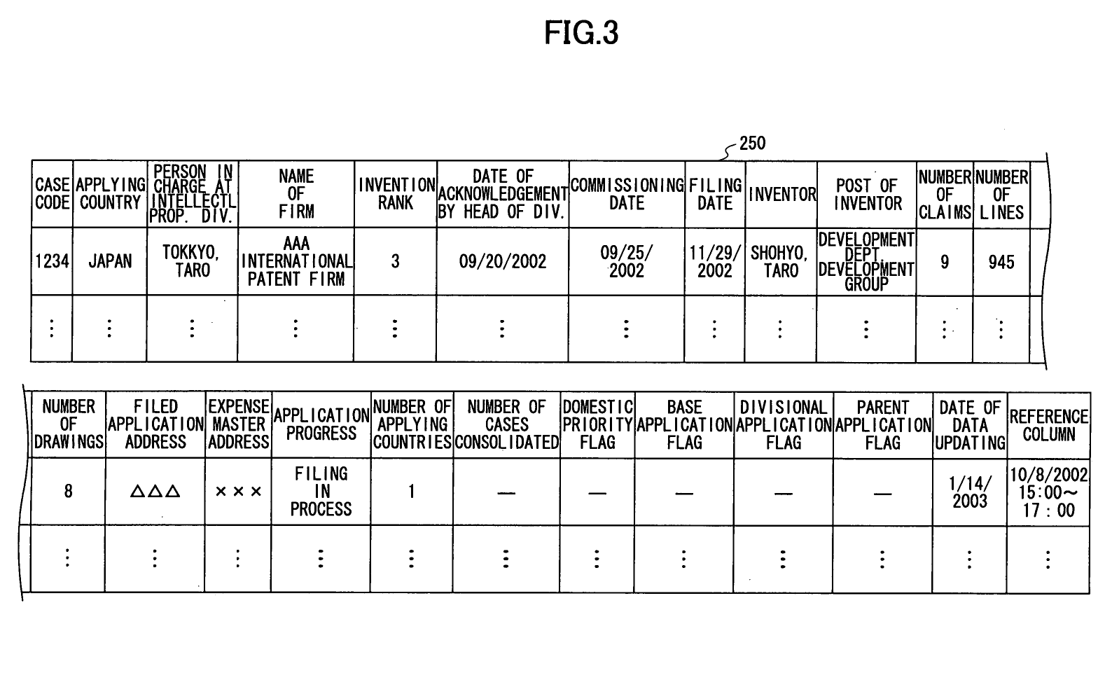

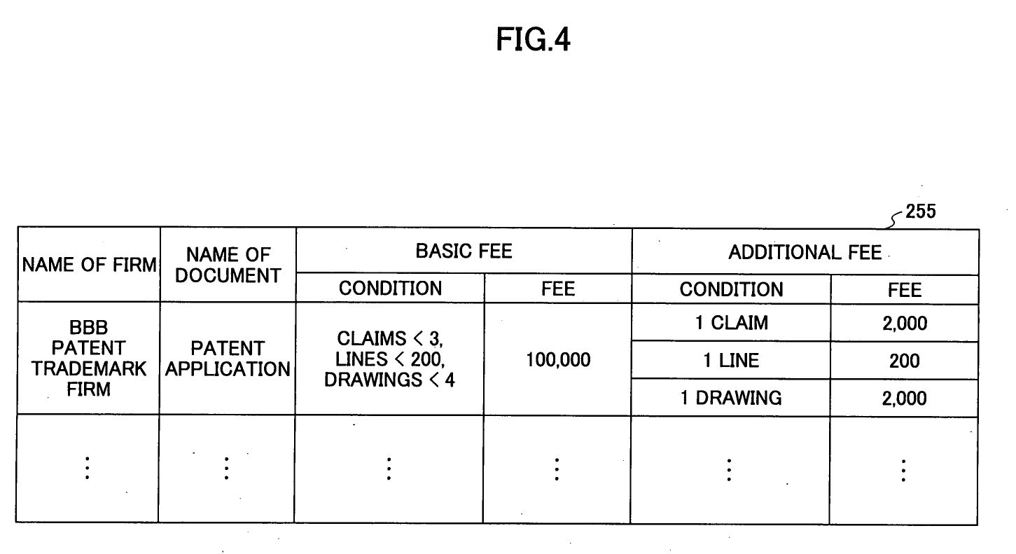

In FIG. 1, the intellectual property expense management server 20 corresponds to a server computer including a CPU (Central Processing Unit) that controls the components described below. The CPU executes the processes of the intellectual property expense management system 10 according to programs stored in a memory unit. The intellectual property expense management server 20 includes a read unit 15 such as an OCR (Optical Character Reader) for optically reading a debit note written on a paper medium and converting the read information into electronic data, an installer 21 for installing a program that executes an intellectual property expense management process, a communication control unit 22 for controlling data communication, an input/output control unit 23 for controlling data input/output, a display control unit 24 for controlling display on a display unit, a debit note information acquisition unit 25 for acquiring debit note information pertaining to payment of expenses, an expense information generation unit 26 for generating expense information based on debit note information, a progress information updating unit 27 for updating information such as progress information pertaining to an application, an information attaching unit 28 for attaching progress information to the corresponding debit note information, an expense information DB 200 for storing and managing generated expense information, a progress information DB 201 for storing and managing progress information, an expense management DB 202 for storing and managing attached information containing expense information and the corresponding progress information attached thereto, a common expense information DB 203 for storing and managing expense information that is shared within the company, a filed application DB 204 for storing and managing filed patent application information that is sent, from the patent firm side terminals 30a˜30x, and an expense master DB 205 for storing and managing expense master information that is used as a standard for generating expense information. It is noted that a configuration of the debit note information is described in FIG. 2, a table that is stored in the progress information DB 201 is described in FIG. 3, and a table that is stored in the expense master DB 205 is described in FIG. 4.

The communication control unit 22 corresponds to a processing unit for controlling transmission/reception of data via the network 1 and includes a communication unit for establishing a connection with the network 1. The input/output unit 23 controls input units such as a mouse and a keyboard, and output units such as a monitor and a printer to control input/output of data. The installer 21 reads programs for realizing processes of the intellectual property expense management system of the present embodiment that are stored in a storage medium 40, and installs the read programs into an auxiliary memory unit, for example. Then, when the intellectual property expense management system operation is started, the CPU starts the operation according to the programs installed in the auxiliary memory unit. It is noted that the storage medium 40 as a medium for storing the operation programs of the intellectual property expense management system 10 may be any type of computer readable medium such as a CD-ROM, for example.

The debit note information acquisition unit 25 obtains electronic data of a debit note that is issued from a patent firm through the read unit 15, or obtains debit note information in electronic data format directly from one of the patent firm side terminals 30a˜30x. Also, the debit note information acquisition unit 25 stores electronic data of the filed applications sent from the patent firm side terminals 30a˜30x in the filed application DB 204. In a case where the filed application is received by mail, the debit note information acquisition unit 25 obtains electronic data of the filed application through the read unit 15 and stores the obtained data in the filed application DB 204. The expense information generation unit 26 generates expense information based on the obtained electronic data of the debit note and the expense master information stored in the expense master DB 205, and stores the generated expense information in the expense information DB 200. Also, the expense information generation unit 26 stores the generated expense information as common expense information in the common expense information DB 203.

The progress information updating unit 27 updates progress information relating to an application that is stored in the progress information DB 201. The progress information stored in the progress information DB 201 contains a number of information items that are preset by the person in charge of management upon commissioning filing of an application, and the progress information is updated each time a debit note is received and expense information is generated. The information attaching unit 28 attaches progress information stored in the progress information DB 201 to the corresponding expense information stored in the expense information DB 200, and stores the attached information in the expense management DB 202. For example, the information attaching unit 28 attaches progress information according to a case code of the expense information.

In the following, procedures for executing an intellectual property expense management operation in the intellectual property expense management server 20 upon receiving a debit note sent from a patent firm or from one of the patent firm side terminals 30a˜30x are described.

After filing of a patent application as commissioned by a company is completed, a patent firm sends debit note information 13 in electronic data format to the intellectual property expense management server 20 of the client company via the network 1 using a patent firm side terminal 30a˜30x to request for payment of fees pertaining to the filing of the application. In turn, the debit note information acquisition unit 25 of the intellectual property expense management server 20 obtains the debit note information, and the expense information generation unit 26 generates expense information based on the obtained debit note information. Then, the progress information updating unit 27 updates the progress information based on the expense information, and the information attaching unit 28 attaches the updated progress information to the expense information of the debit note and stores the attached information in the expense management DB 202.

It is noted that the debit note may not be sent from the patent firm as debit note information 13 in electronic data format, and instead the debit note may be written on a paper medium 12 and sent to the intellectual property expense management server 20. In such case, the read unit 15 of the intellectual property expense management server 20 may read the debit note on the paper medium 12 and convert the read information into electronic data, and the intellectual property expense management operation may be performed in the manner described above on the electronic data produced by the read unit 15.

By managing the attached information containing expense information and the corresponding progress information attached thereto, auditing of the application may be performed based on the progress information. Also, along with the attached information for auditing purposes, expense information that is shared within the company may be stored and managed. By managing the expense information containing minimal information as common expense information, confidential application information may be protected from risks of leakage without having to extract or erase such information, and expense information may be efficiently managed.

It is noted that the patent firm side terminals 30a˜30x may correspond to any type of apparatus that is capable of transmitting electronic data of a debit note such as a server computer or a personal computer (PC).

In the following, the debit note on a paper medium 12 and the debit note in electronic data format 13 are described.

FIG. 2 is a diagram illustrating an example of a debit note that may be written on a paper medium or be in electronic data format. Referring to FIG. 2, a case in which the debit note in electronic data format 13 is displayed as a screen 300 on a display unit of the intellectual property expense management server 20 is described below. The screen 300 includes a display area 301 for indicating information such as the date of transmission and the destination of the debit note, for example, a display area 302 for indicating information on the issuer of the debit note and the relevant case, for example, and a table 303 giving a detailed analysis of the expense, for example. In FIG. 2, the display area 301 indicates a title of the display screen, “Debit Note”, the date of transmission, “Jan. 14, 2003”, the name of the company to which the debit note is addressed, “Company R, Ltd.”, and a note reading, “sum of charge is indicated below”. Also, the display area 302 indicates the creditor code, “1111”, indicating a code for the patent firm issuing the debit note, the name of the creditor patent firm, “AAA International Patent Firm”, and a case code, “1234”, that is assigned by the commissioning company. The table 303 includes a column indicating a breakdown of the expenses (expense items) and a column indicating the corresponding fees being charged (charge). For example, in the table 303 of FIG. 2, a sum “100,000” is indicated in the charge column for the expense item, “Patent Application Filing Fee”, and a sum “128,100” is indicated in the charge column for the expense item “Total”.

The debit note information indicated in the screen 300 is obtained by the debit note information acquisition unit 25, and expense information is generated by the expense information generation unit 26 and stored in the expense information DB 200. Common expense information is generated and stored in the common expense information DB 203.

As is shown, the debit note indicated in the screen 300 reveals minimal information so that when communication cannot be established between the patent firm and the company using the private line connecting the two parties, a public network such as the Internet may be used to transmit the information from the patent firm side terminal 30a˜30x to the company side intellectual property expense management server 20 with little risk of information leakage. Also, by generating expense information based on debit note information including minimal information and managing the generated expense information in the common expense information DB 203, information leakage may be prevented, and at the same time, expense information may be efficiently managed.

In the following, progress information stored in the progress information DB 201 is described.

FIG. 3 is a table illustrating progress information stored in the progress information DB 201. In FIG. 3, the table 250 stored in the progress information DB 201 is preset by the managing staff at the time an order is made for the filing of an application, and the progress information is updated every time a debit note is received. The table 250 includes a column for indicating the case code of the application order, a column for indicating the designated country (countries) to which the application is to be filed, a column for indicating the person in charge of the application at the intellectual property department division (intellectual property division), a column for indicating the name of the patent firm to which the order has been made, a column for indicating the rank of the invention, and a column for indicating the date of approval by the chief of the intellectual property division, a column for indicating the date of making the order to the patent firm, a column for indicating the filing date, a column for indicating the inventor name, a column for indicating the post of the inventor, a column for indicating the number of claims, a column for indicating the number of lines contained in the application, a column for indicating the number of drawings, a column for indicating the storage address of the filed application, a column for indicating the storage address of the expense master information, a column for indicating the progress of the application filing, a column for indicating the number of countries to which the application is being filed, a column for indicating the number of cases being consolidated, a column for indicating a flag signaling whether domestic priority is being claimed, a column for indicating a flag signaling whether a base application exists, a column for indicating a flag signaling whether a divisional application is filed, a column for indicating a flag signaling whether a parent application exists, a column for indicating the date of updating of the progress information, and a reference column for indicating miscellaneous information such as the interview date, for example.

For example, in the table 250 of FIG. 3, “1234” is stored as the case code, “Japan” is stored as the designated applying country, “Tokkyo, Taro” is stored as the name of the person in charge at the intellectual property division, “AAA International Patent Firm” is stored as the name of the patent firm undertaking the order, “3” is stored as the invention rank, “Sep. 20, 2002” is stored as the intellectual property division chief acknowledgement date, “Sep. 25, 2002” is stored as the commissioning date to the patent office, “Nov. 29, 2002” is stored as the filing date, “Shohyo, Taro” is stored as the name of the inventor, “development department development group” is stored as the post of the inventor, “9” is stored as the number of claims, “945” is stored as the number of lines contained in the application, “8” is stored as the number of drawings, “ΔΔΔ” is stored as the filed application address, “×××” is stored as the expense master address, “filing in process” is stored as the application progress, “1” is stored as the number of applying countries, “−” is stored as the consolidation cases, “−” is stored as the domestic priority flag, “−” is stored as the base application flag, “−” is stored as the divisional application flag, “−” is stored as the parent application flag, “Jan. 14, 2003” is stored as the data updating date, and “15:00˜17:00, 10/08/2002” is stored in the reference column.

Based on the case code of the progress information indicated in the table 250, the progress information may be attached to the expense information of FIG. 2, and auditing of the application may be performed while realizing efficient management of the expense information.

It is noted that columns included in the table 250 are not limited to those described above; rather, columns for other information items may be added and columns may be removed as necessary or desired.

In the following, the expense master information that is stored in the expense master DB 205 is described.

FIG. 4 is a table illustrating an example of the expense master information stored in the expense master DB 205. In FIG. 4, the table 255 stored in the expense master DB 205 corresponds to a table that is referred to by the expense information generation unit 25 upon generating expense information based on the debit note information. The table 255 includes a column for indicating the name of the patent firm, a column for indicating the document name, a column for indicating the basic charge for a document satisfying predetermined conditions, a column for indicating additional charges for conditions other than the predetermined conditions. For example, the table 255 of FIG. 4 stores patent firm name “BBB Patent and Trademark Firm”, document name “Patent Application”, price “100,000” as the basic charge for a document fulfilling the conditions “claims<3, lines<200, drawings<4”, and price “2,000” for “1 claim”, price “200” for “1 line”, and price “2,000” for “1 drawing” as additional charges.

By generating expense information based on the debit note information and the expense master information represented by the table 255, the details of the debit note sent from each patent firm may be checked, and accurate expense information may be managed. Also, the generated expense information may be managed as common expense information.

In the following, intellectual property expense management operation procedures performed by the intellectual property management server 20 are described.

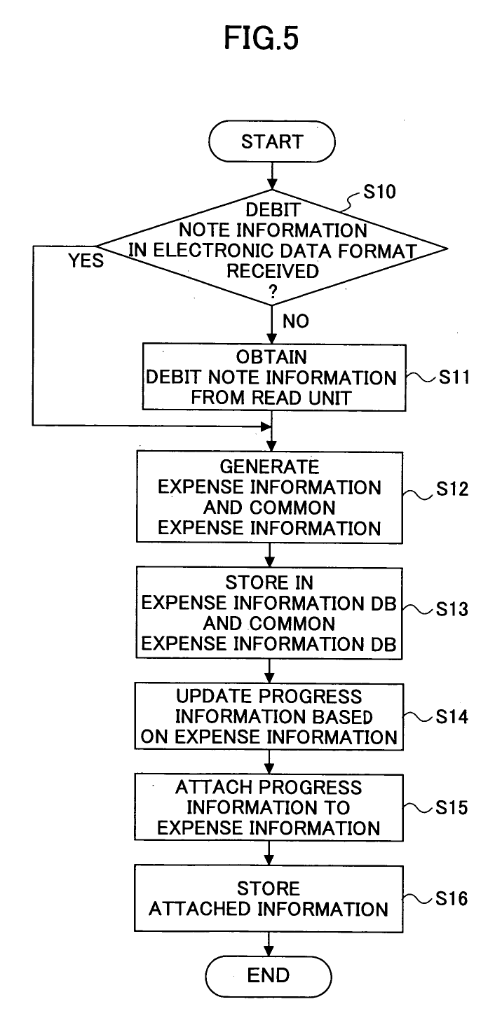

FIG. 5 is a flowchart illustrating the intellectual property expense management process. According to FIG. 5, first, in step S10, the debit note information acquisition unit 25 of the intellectual property expense management server 20 determines whether debit note information in electronic data format 13 has been received from one or more of the patent firm side terminals 30a˜30x. If debit note information in electronic data format 13 is not received in step S10, the read unit 15 reads a debit note on a paper medium 12 and the debit note information acquisition unit 25 obtains electronic data of the debit note in step S11. If debit note information in electronic data format 13 is received in step S10, the expense information generation unit 26 generates expense information and common expense information based on the debit note information and the expense master information stored in the expense master DB 205 in step S12. Then, in step S13, the expense information generation unit 26 stores the generated expense information in the expense information DB 200, and stores the common expense information in the common expense information DB 203. Then, in step S14, the expense information updating unit 27 updates the progress information stored in the progress information DB 201 such as the filing date based on the expense information. Then, in step S15, the information attaching unit 28 attaches the progress information to the corresponding expense information. In step S16, the information attaching unit 28 stores the attached information containing the expense information and the corresponding progress information attached thereto in the expense management DB 202.

As is described above, at the company side intellectual property expense management server 20, expense information is generated based on debit note information, and attached information containing the expense information and its corresponding progress information is managed so that auditing of the application may be performed. Also, by managing the expense information as common expense information that is shared within the company, information leakage may be prevented. In this way, expenses generated within a company may be efficiently managed.

In the following, an expense management system according to a second embodiment of the present invention is described.

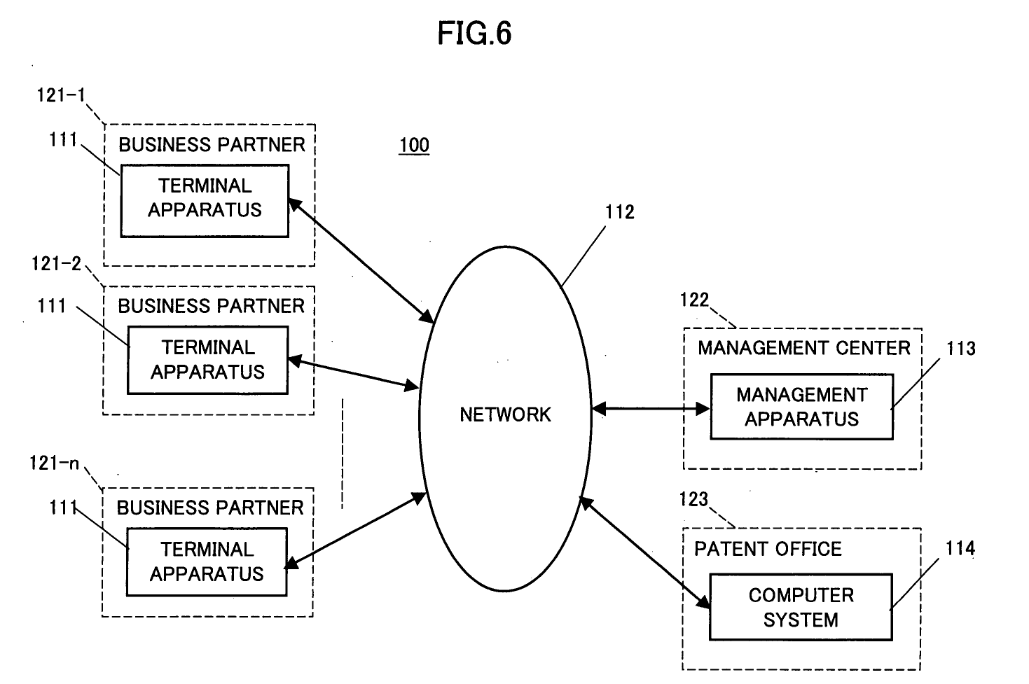

FIG. 6 is a block diagram illustrating an exemplary configuration of an expense management system according to the second embodiment of the present invention.

The expense management system 100 of FIG. 6 corresponds to a system for managing expenses pertaining to applications for intellectual property rights such as patents and includes terminal apparatuses 111, a network 112, a management apparatus 113, and a computer system 114. The terminal apparatuses 111 are stationed at business partners 121-1˜121-n. The terminal apparatus 111 is adapted to send a document to the computer system 114 stationed at Patent Office 123 via the network 112. The document being sent may correspond to an application document that is to be submitted to the Patent Office 123. The network 112 may correspond to the Internet and is adapted to establish communication between the terminal apparatuses 111, the management apparatus 113, and the computer system 114 of the Patent Office 123.

Also, the terminal apparatus 111 generates an invoice and a debit note based on reception information that is included in a transmission message sent from the computer system 114 of the Patent Office 123, and sends the generated documents to the management apparatus 113 that is stationed at a management center 122. The management apparatus 113 stationed at the management center 122 is adapted to receive and manage the invoices and debit notes sent from the terminal apparatuses 111, and perform processes for verifying the accuracy of the documents and estimating expenses based on past performances.

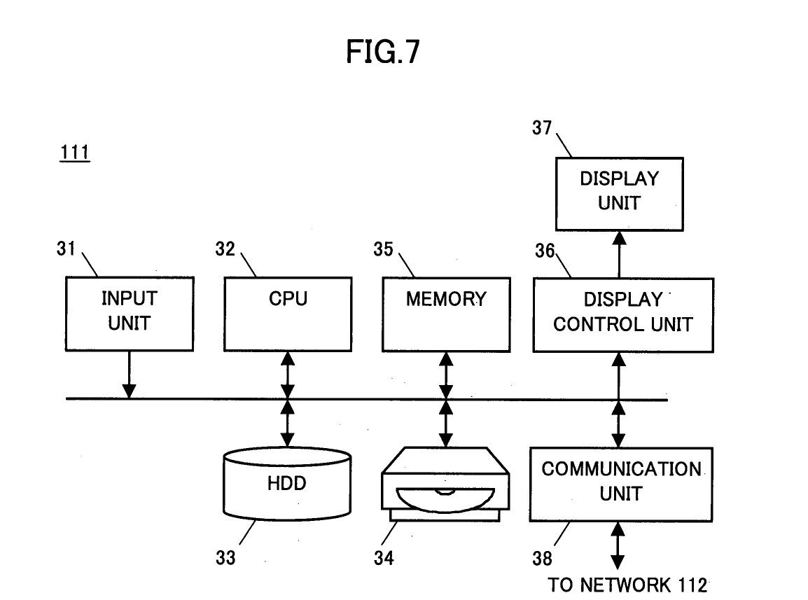

FIG. 7 is a block diagram illustrating a configuration of the terminal apparatus 111.

The terminal apparatus 111 may correspond to a personal computer, for example, and includes an input unit 31, a CPU 32, a hard disk drive 33, an interchangeable storage unit 34, a memory 35, a display control unit 36, a display unit 37, and a communication unit 38.

The input unit 31 is used for inputting processing instructions and data, and may correspond to a mouse and a keyboard, for example. The CPU (central processing unit) 32 executes processes according to programs installed in the hard disk drive 33 based on the instructions and data input by the input unit 31.

The interchangeable storage unit 34 may correspond to an optical disk drive such as a CD-ROM drive, a CD-R/RW drive, a DVD-ROM drive, a DVD-RAM drive, or a DVD-R/RW drive. The interchangeable storage unit 34 may read the programs stored in the interchangeable disk set therein and install the read programs in the hard disk drive 33, read desired data from the interchangeable disk, or write data onto the interchangeable disk for storage or backup of data stored in the hard disk drive 33.

The memory 35 corresponds to a RAM (random access memory) and is used as a working memory area for the CPU 32.

The display control unit 36 may correspond to a graphics chip or a graphics board, for example. The display control unit 36 develops image data according to the processes executed by the CPU 32, and performs control processes for administering the display unit 37 to display an image according to the developed image data. The display unit 37 may correspond to a CRT (cathode ray tube) or a LCD (liquid crystal display), for example, and is adapted to display the image developed by the display control unit 36 on its screen.

It is noted that an electronic application filing program for filing an electronic application to the Patent Office on-line and an invoice/debit note issuing program for issuing an invoice and a debit note pertaining to a filed application to the management center 122 are installed in the terminal apparatus 111.

In the following, the electronic application filing program is described.

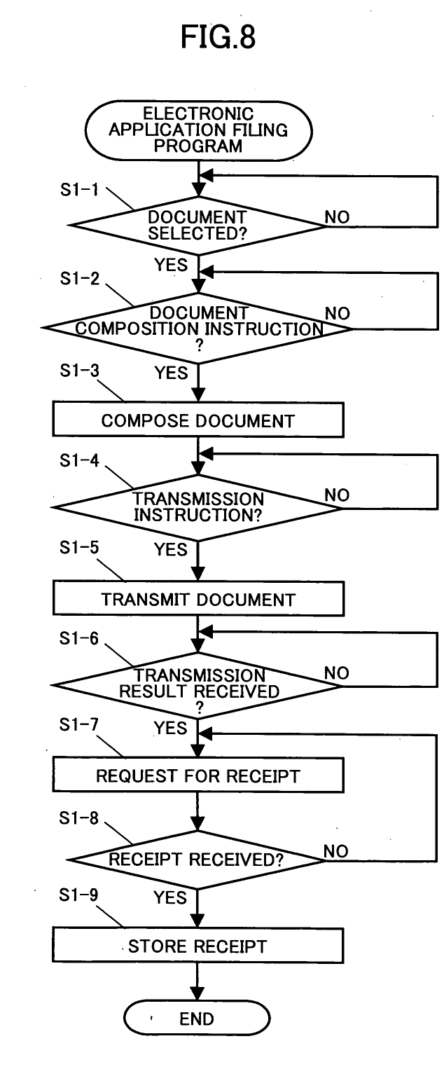

FIG. 8 is a process flowchart illustrating the processes of the electronic application filing program installed in the terminal apparatus 111.

As is shown in this flowchart, the terminal apparatus 111 may select one or more documents such as the application request, the specification and claims, and the drawings, for example. If documents are selected (step S1-1 Y), the process moves on to step S1-2. In step S1-2, if a document composition instruction is issued (step S1-2 Y), the documents such as the application request, the specification and claims, and the drawings selected in step S1-1 are composed into application documents (step S1-3).

Then, when a transmission instruction is issued (S1-4 Y), the terminal apparatus 111 sends the composed application documents to the computer system 114 of the Patent Office 123 (step S1-5). In turn, the computer system 114 of the Patent Office 123 receives the application documents from the terminal apparatus 111, and sends a transmission result to the terminal apparatus 111. After the terminal apparatus 111 receives the transmission result from the computer system 114 of the Patent Office 123 (step S1-6 Y), it requests for a filing receipt (step S1-7).

Upon receiving the request for the filing receipt from the terminal apparatus 111, the computer system 114 of the Patent Office 123 sends the filing receipt to the terminal apparatus 111.

After the terminal apparatus 111 receives the filing receipt from the computer system 114 of the Patent Office 123 (step S1-8 Y), it stores the filing receipt (step S1-9).

In the following, the invoice/debit note issuing program is described.

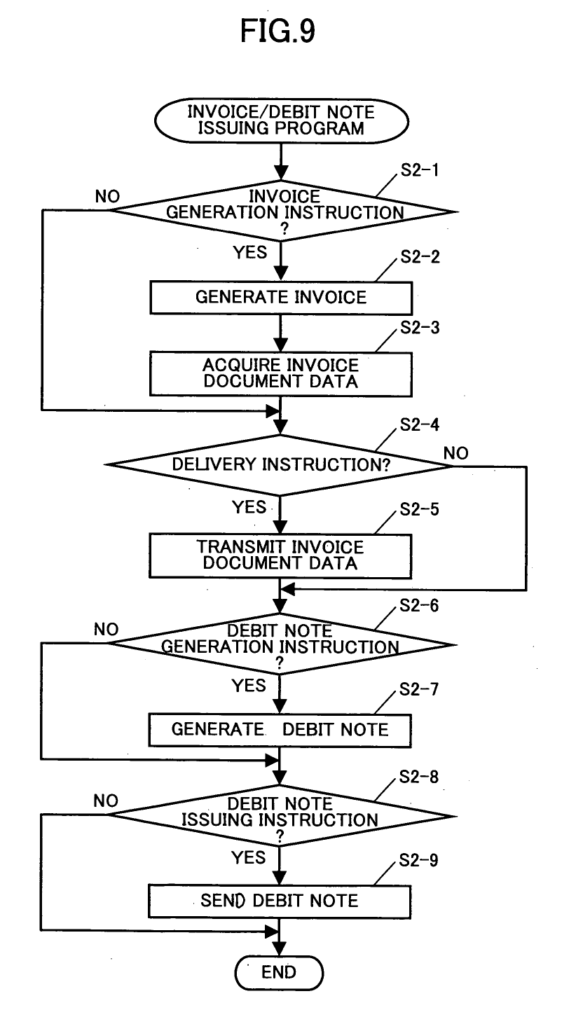

FIG. 9 is a process flowchart illustrating processes of the invoice/debit note issuing program installed in the terminal apparatus 111.

Referring to this flowchart, in step S2-1, the terminal apparatus 111 receives the filing receipt, and if an invoice generation instruction is issued (step S2-1 Y), the terminal apparatus 111 generates the invoice in step S2-2. Then, in step S2-3, an instruction to acquire supplied articles is issued, in response to which the terminal apparatus 111 automatically acquires the relevant documents such as the application request, the specification and claims, and the drawings, and attaches the acquired documents to the invoice.

Then, when an invoice delivery instruction is issued, (step S2-4 Y), the terminal apparatus 111 sends the invoice and the attached documents such as the application request, the specification and claims, and the drawings to the management apparatus 113 via the network 112 (step S2-5).

Then, when a debit note generation instruction is issued (step S2-6 Y), the terminal apparatus 111 generates the debit note (step S2-7). For example, in the case of a patent application, the number of claims, the number of lines and the number of drawings are automatically extracted. Then, the charged fee is calculated from the extracted information on the number of claims, the number of lines, and the number of drawings, based on predetermined calculation conditions. As an example of fee calculation conditions, a basic fee of 100,000 yen may be set for 3 claims, 200 lines, and 4 drawings, and additional fee charge conditions may be set such as 2,000 yen for each additional claim, 200 yen for each additional line, 2,000 yen for each additional drawing. As another example of fee calculation conditions, a coefficient may be multiplied to a basic fee according to the importance of the application.

Thus, the generated debit note reflects the fees calculated based on such fee calculation conditions.

Then, when a debit note issuing instruction is issued (step S2-8 Y), the terminal apparatus 111 sends the debit note to the management apparatus of the management center 122 via the network 112 (step S2-9).

In this way, a debit note may be issued by the terminal apparatus 111 and sent to the management apparatus 113.

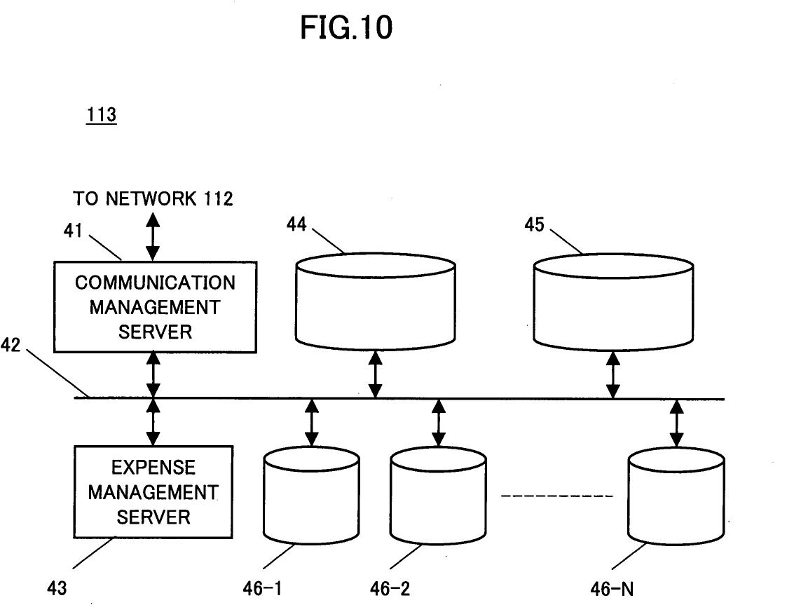

FIG. 10 is a block diagram illustrating a configuration of the management apparatus 113.

The management apparatus 113 includes a communication management server 41, a local area network (LAN) 42, an expense management server 43, a debit note database 44, a patent common master database 45, business partner databases 46-1˜46-n.

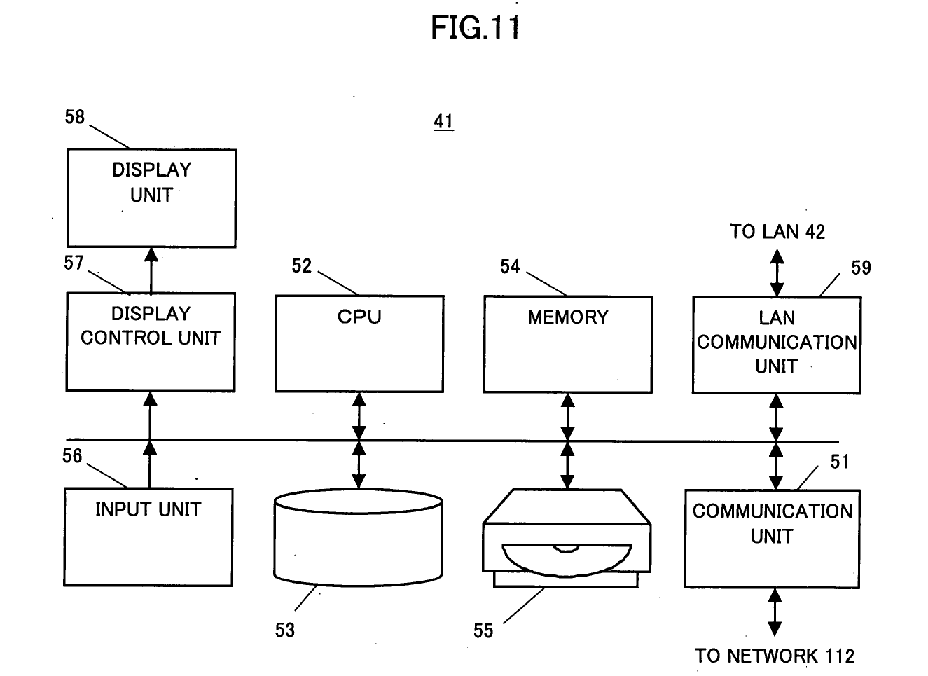

FIG. 11 is a block diagram illustrating a configuration of the communication management server 41.

The communication management server 41 includes a communication unit 51, a CPU 52, a hard disk drive 53, a memory 54, an interchangeable storage unit 55, an input unit 56, a display control unit 57, a display unit 58, and a LAN communication unit 59.

The communication unit 51 performs communication control with the network 112, and the CPU 52 performs communication control between the network 112 and the LAN 24 based on communication control programs installed in the hard disk drive 53. The memory 54 may correspond to a RAM, for example, and is used as a working memory area for the CPU 52. The interchangeable storage unit 55 may correspond to an optical disk drive as described above, and may be adapted to, for example, read information from an interchangeable disk set therein, install or update communication control programs, input data, and write data on the interchangeable disk for backup.

The input unit 56 is for inputting instructions and data, and may include a mouse and a keyboard, for example. The display control unit 57 controls the displaying of data pertaining to a communication state by controlling the display unit 59 corresponding to a CRT or an LCD, for example. The LAN communication unit 59 controls communication of the LAN 42.

The communication management server 41 having the above configuration realizes an interface with the network 112 and the LAN 42, and controls the communication between the management server 43, the debit note database 44, the patent common master database 45, and the business partner databases 46-1˜46-n.

The management server 43 is adapted to receive the debit note from the terminal apparatus 111 and manage the generated expenses.

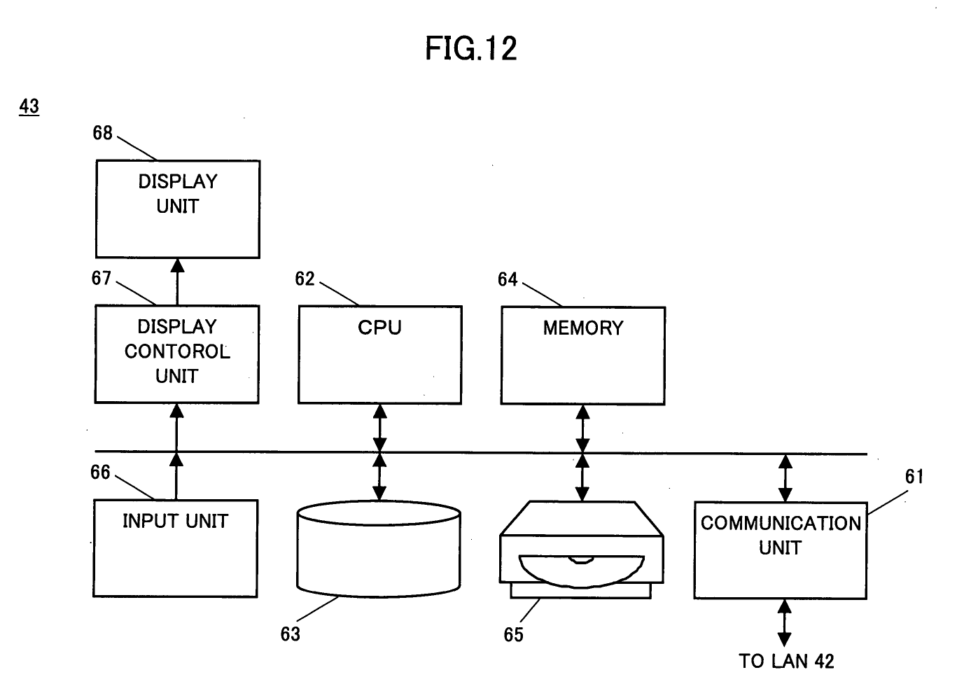

FIG. 12 is a block diagram illustrating a configuration of the management server 43.

The management server 43 includes a communication unit 61, a CPU 62, a hard disk drive 63, a memory 64, an interchangeable storage unit 65, an input unit 66, a display control unit 67, and a display unit 68.

The communication unit 61 controls communication with the LAN 42. The CPU 62 manages debit notes based on a management program installed in the hard disk drive 63. The memory 64 is used as a working memory area for the CPU 62. The interchangeable storage unit 65 may correspond to an optical disk drive such as those described above, and may be adapted to read the management program from the interchangeable disk and install or update the program, or record data onto the interchangeable disk for backup and storage, for example. The input unit 66 is for inputting instructions and data pertaining to the management program. The display control unit 67 controls the displaying of debit notes and other various types of data by controlling the display unit 68.

In the following, processes of the management program executed at the expense management server 43 are described.

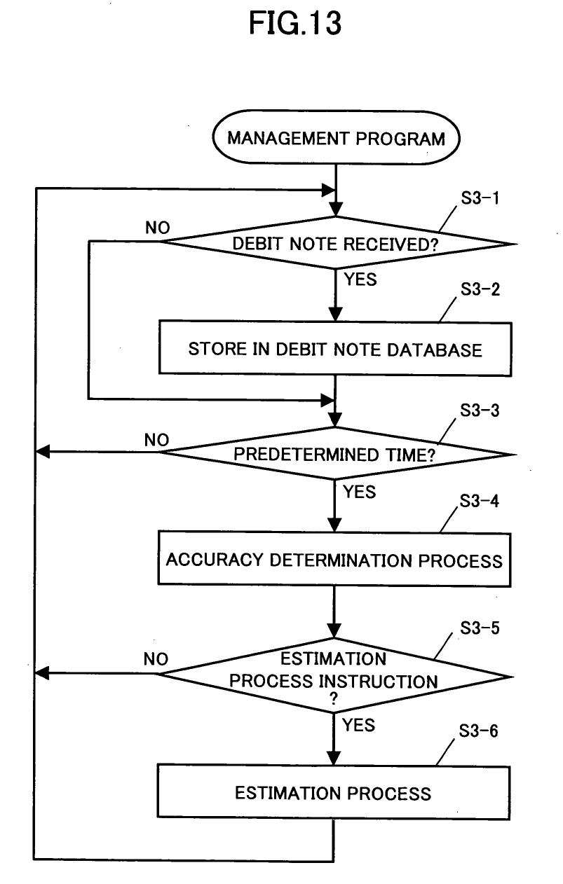

FIG. 13 is a process flowchart illustrating the management program that is executed at the expense management server 43.

According to this flowchart, when the expense management server 43 receives a debit note from the terminal apparatus 111 (step S3-1 Y), it accumulates the received debit note in the debit note database 44 (step S3-2).

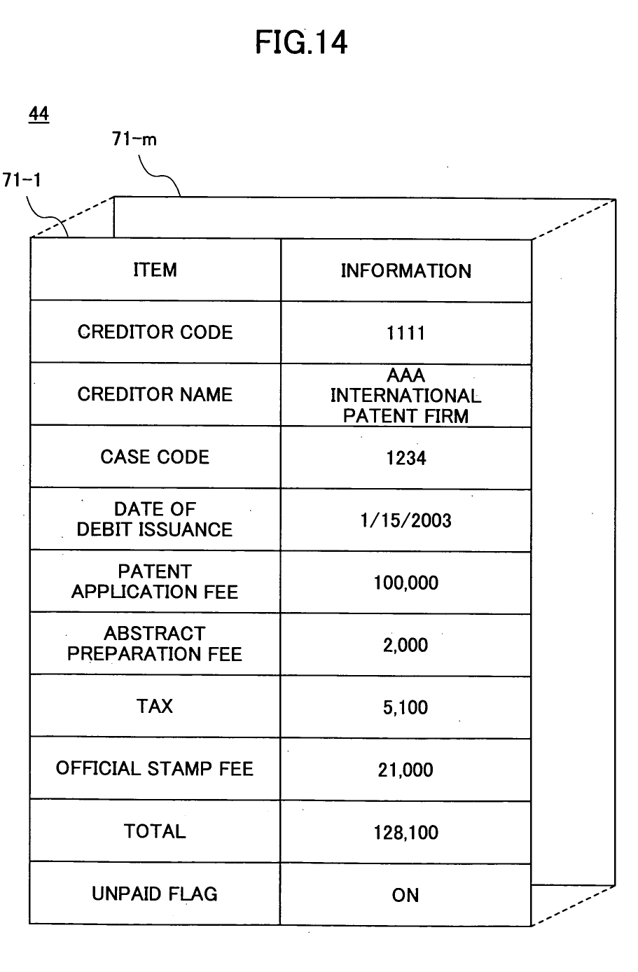

FIG. 14 is a table illustrating an exemplary data configuration of the debit note database 44 pertaining to step S3-2 of FIG. 13 (step S3-3˜S3-6 to be described later).

In the debit note database 44, debit note information sets 71-1˜71-m issued by the terminal apparatus 111 are stored.

The debit note information set 71-1 includes information on a creditor code, a creditor name, a case code, a date of debit issuance, a patent application fee, an abstract preparation fee, tax, an official stamp fee, a total, and an unpaid flag, for example.

The creditor code corresponds to a code that is pre-assigned to the patent firm issuing the debit note, and is included in the debit note being sent from the terminal apparatus 111. The creditor name corresponds to the name of the patent firm issuing the debit note, and this is also included in the debit note being sent from the terminal apparatus 111.

The case code corresponds to a code that is pre-assigned to the case for which a fee is being charged, and this code is also included in the debit note being sent from the terminal apparatus 111. The date of debit issuance corresponds to information pertaining to the date on which the debit note is issued, and this information may be included in the debit note being sent from the terminal apparatus 111 or this information may be provided at the management apparatus 113 upon receiving the debit note.

The patent application fee corresponds to information pertaining to the fee being charged, and this information is included in the debit note being sent from the terminal apparatus 111. The abstract preparation fee corresponds to information pertaining to the fee being charged for preparing an abstract that is attached to the patent application, and this information is also included in the debit note being sent from the terminal apparatus 111. The tax corresponds to information on the tax being charged for the fees pertaining to the patent application, and this information is also included in the debit note being sent from the terminal apparatus 111.

The official stamp fee corresponds to information on the payment made to the Patent Office upon conducting application procedures, and this information is included in the debit note being sent from the terminal apparatus 111. The total corresponds to information indicating a total of the fees being charged. The unpaid flag corresponds to a flag indicating whether payment has been made, and for example, the flag may be turned on when payment is not yet made, and turned off when payment has already been made.

After a predetermined time period passes (step S3-3 Y), the management server 43 conducts an accuracy determination process for verifying the accuracy of the fee being charged (step S3-4).

In the following, the accuracy determination process is described.

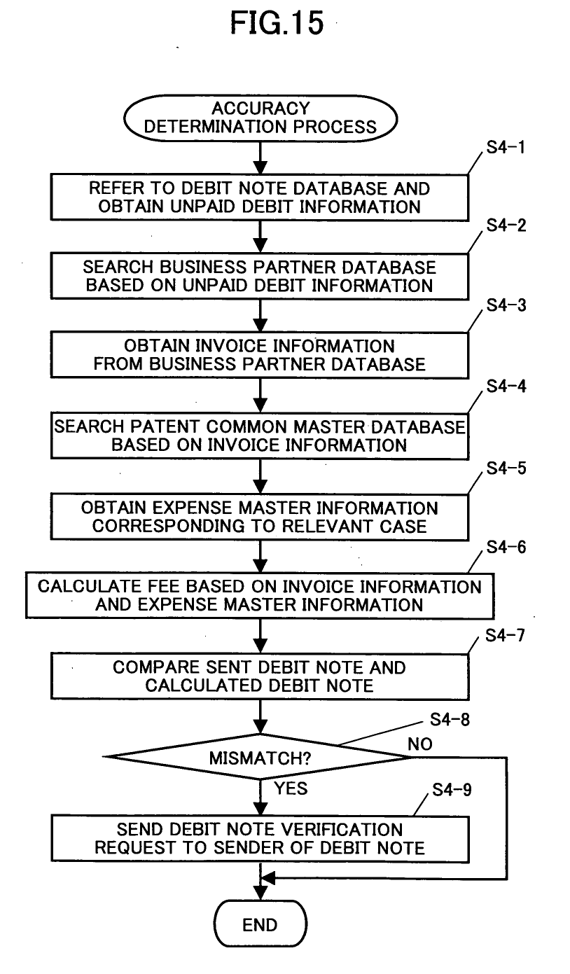

FIG. 15 is a process flowchart illustrating the accuracy determination process of step S3-4 of FIG. 13 executed by the management server 43 (step S3-5˜S3-6 to be described later).

First, in step S4-1, the management server 43 checks the unpaid flags of the debit notes stored in the debit note database 44, and acquires a debit note having the unpaid flag turned on, namely, one of the debit notes for which payment is not yet made. In step S4-2, the management server 43 searches for the patent firm corresponding to the creditor of the debit note based on the creditor code and/or creditor name provided in the acquired debit note, and searches for the business partner database 46-i storing data pertaining to the creditor patent firm.

In the following, a data configuration of the business partner database 46-i is described.

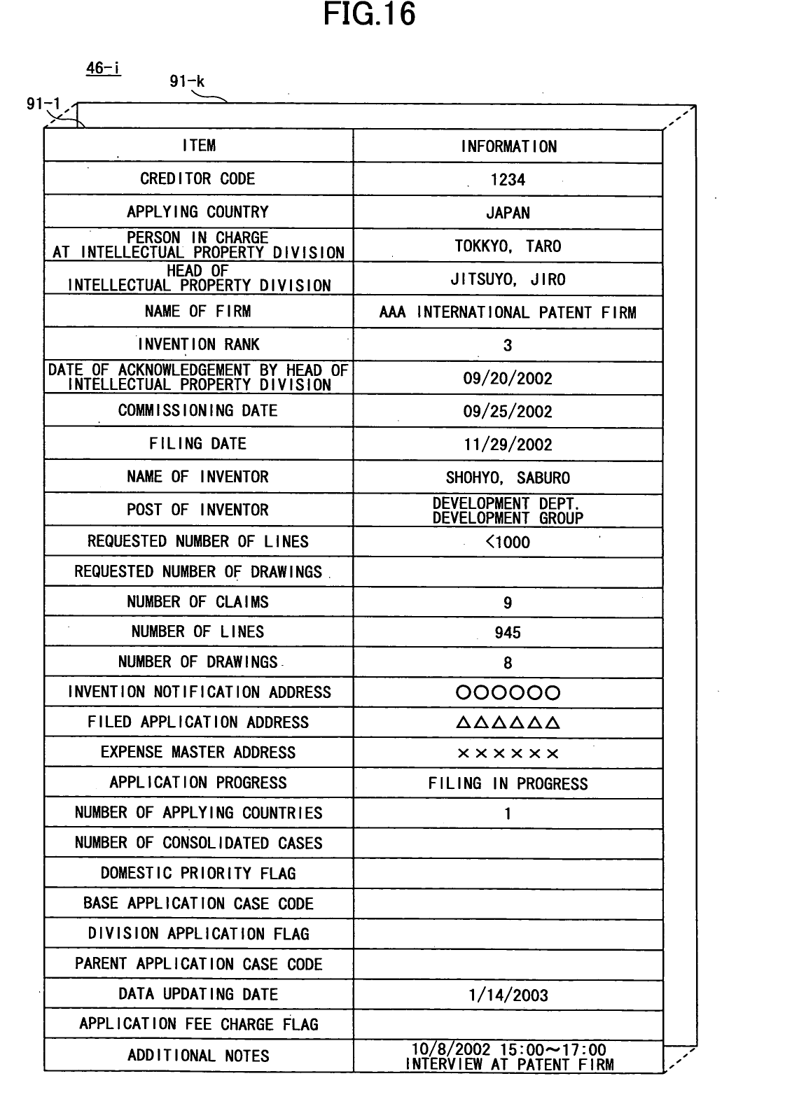

FIG. 16 is a table illustrating an exemplary data configuration of the business partner database 46-i of FIG. 10 pertaining to step S4-2 of FIG. 15 (step S4-3˜S4-9 and step S3-5˜S3-6 to be described later).

The business partner database 46-i stores invoice information 91-1˜91-k corresponding to respective cases handled by the relevant business partner firm. The invoice information 91-1 includes information items such as “case code”, “applying country”, “person in charge at intellectual property division”, “head of intellectual property division”, “name of firm”, “invention rank”, “date of acknowledgement by head of intellectual property division”, “commissioning date”, “filing date”, “name of inventor”, “post of inventor”, “requested number of lines”, “requested number of drawings”, “number of claims”, “number of lines”, “number of drawings”, “invention notification address”, “filed application address”, “expense master address”, “application progress”, “number of applying countries”, “number of consolidated cases”, “domestic priority flag”, “base application case code”, “division application flag”, “parent application case code”, “data updating date”, “application fee charge flag”, and “additional notes”, for example. The information corresponding to such information items is set based on an order letter and the invoice of the relevant case, for example.

The “case code” indicates a pre-assigned code for identifying the relevant case. The “applying country” indicates information on the country to which the case is filed. The “person in charge at intellectual property division” indicates information such as a name and code of the individual in charge of the case. The “head of intellectual property division” indicates information for identifying the supervisor of the person in charge of the case, and may include a name and code of the corresponding individual.

The “name of firm” indicates information for identifying the firm to which the case has been commissioned, and may include a name and code of the firm. The “invention rank” indicates a ranking of the case, and fees for the case may be determined based on this rank, for example. The “date of acknowledgement by head of intellectual property division” indicates the date on which the head of the intellectual property division in charge has acknowledged the case.

The “commissioning date” indicates the date on which the case is commissioned to the firm. The “filing date” indicates the date on which the case is filed, and this information may be obtained from the invoice, for example. The “inventor name” indicates information for identifying the inventor for the case, and may include a name and code of the inventor. The “post of the inventor” indicates information on the post to which the inventor is assigned, and may include a name and code of the post. The “requested number of lines” indicates the number of lines designated at the time an application order is made, and this information may be obtained from the order letter, for example. The “requested number of drawings” indicates the number of drawings provided at the time an application order is made, and this information may also be obtained from the order letter, for example.

The “number of claims” indicates the number of claims contained in the application at the time of filing, and this information may be obtained from the invoice and the documents attached to the invoice, for example. The “number of lines” indicates the number of lines contained in the filed application, and this information may also be obtained from the invoice and documents attached thereto. The “number of drawings” indicates the number of drawings included in the filed application, and this information may also be obtained from the invoice and documents attached thereto. The “invention notification address” indicates information on the address of the storage location of the invention notification. The “filed application address” indicates information on the address of the storage location of the filed application delivered with the invoice. The “expense master address” indicates information on the address of the storage location of the expense master information for calculating the expenses for the case.

The “application progress” indicates information on the progress of the case. The “number of applying countries” indicates the number of countries to which the case is filed. The “number of consolidates cases” indicates the number of cases that are consolidated. The “domestic priority flag” indicates whether domestic priority is claimed. The “base application case code” indicates a code for identifying the base application.

The “division application flag” indicates whether application division is performed. The “parent application case code” indicates a code for identifying a parent application. The “data updating date” indicates the date on which the information corresponding to the information items described above has been updated. The “application fee charge flag” indicates whether the application fee has been charged. The “additional notes” indicates information such as the date, time and location of an interview, for example.

Returning back to FIG. 15, in step S4-3, the management server 43 obtains relevant invoice information 91-i from the business partner database 46-i. Then, in step S4-4, the management server 43 refers to the patent common master database 45 to obtain the expense master information corresponding to the relevant case.

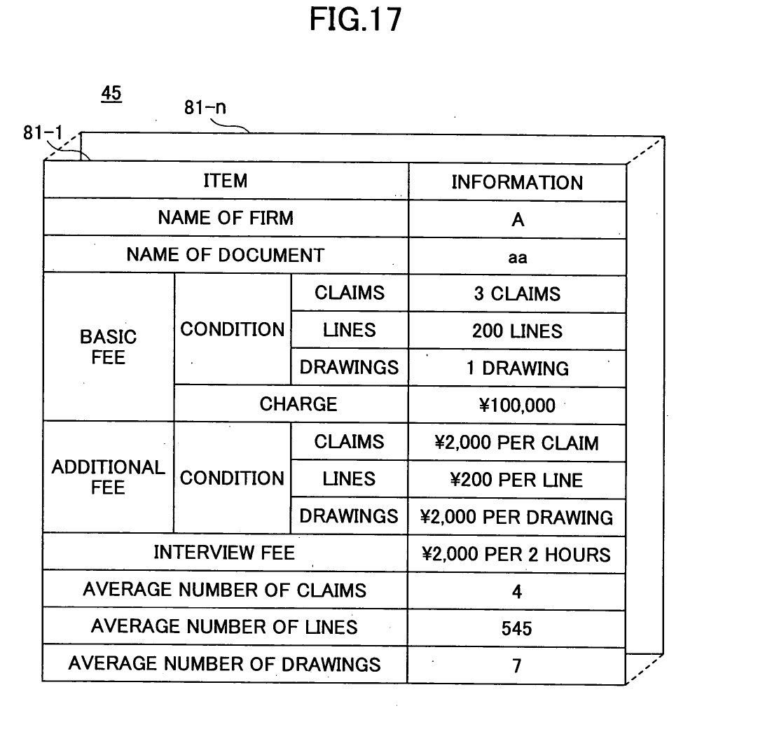

FIG. 17 is a table illustrating an exemplary data configuration of the patent common master database 45 of FIG. 10 pertaining to step S4-3 of FIG. 15 (step S4-5˜S4-9 and step S3-5˜S3-6 to be described later).

The patent common master database 45 stores expense master information 81-1˜81-n corresponding to each business partner firm and type of document, for example.

The expense master information 81-1 includes information items such as “name of firm”, “name of document”, “basic fee”, “additional fee”, “interview fee”, “average number of claims”, “average number of lines”, and “average number of drawings”.

The “name of firm” indicates the name of a business partner firm. The “name of document” indicates the type of document to be handled. The “basic fee” indicates information on a basic fee for the firm to undertake proceedings of the indicated document, and includes the conditions and the amount being charged. For example, a basic number of claims, a basic number of lines, and a basic number of drawings may be provided as the conditions of the basic fee. In the expense master information 81-1, the basic fee is indicated as 100,000 yen for 3 claims, 200 lines, and 1 drawing.

The “additional fee” indicates information on additional fees that are charged when conditions of a case exceed the basic conditions for the basic fee. For example, an additional claim fee, an additional line fee, an additional drawing fee may be provided. In the expense master information 81-1, the additional claim fee charged for each additional claim is indicated as 2,000 yen, the additional line fee charged for each additional line is indicated as 200 yen, and the additional drawing fee charged for each additional drawing is indicated as 2,000 yen.

The “interview fee” indicates information on the fee that is charged for holding an interview, and for example, a fee of 20,000 yen may be charged per 2 hours. The “average number of claims” indicates the average number of claims contained in an application handled by the firm (e.g., 4 claims). The “average number of lines” indicates the average number of lines contained in the filed application handled by the firm (e.g., 545 lines). The “average number of drawings” indicates the average number of drawings filed with the application documents (e.g., 7 drawings).

Returning back to FIG. 15, in step S4-5, the management server 43 obtains corresponding expense master information 81-i for to the relevant case. Then, in step S4-6, the management server 43 calculates the fees for proceeding with the case by applying the expense master information 81-i to the information on the number of claims, the number of lines, and the number of drawings obtained from the invoice information 91-i. In this way, fees for the number of claims, the number of lines, the number of drawings, the tax, and the total amount of fees may be calculated.

Then, in step S4-7, the management server 43 compares the fees calculated in step S4-6 with the fees indicated in the debit note sent from the terminal apparatus 111. In step S4-8, the management server 43 determines whether the calculated fees and the fees indicated in the sent debit note correspond. If the fees do not correspond (step S4-8 Y), the process moves on to step S4-9 where the management server 43 sends a debit note verification request to the business partner firm 121-i corresponding to the issuer of the debit note.

In this way, the accuracy of the debit note may be automatically verified, and when there is an error in the debit note, a request to make corrections on the debit note may be sent to the business partner issuing the debit note. It is noted that the request to make corrections on the debit note may be sent to the business partner firm after the person in charge of the case at the company side checks the corrections to be made.

Referring back to FIG. 13, after the accuracy determination process is performed, the management server 43 determines whether an estimation process instruction is issued in step S3-5. If the estimation process instruction is issued (step S3-5 Y), the estimation process is conducted in step S3-6.

In the following, the estimation process is described.

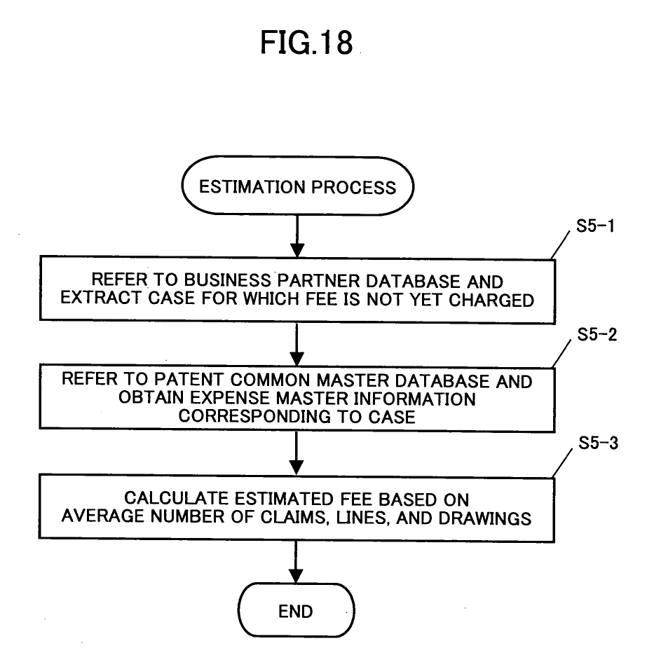

FIG. 18 is a process flowchart illustrating the estimation process executed by the management server 43 of FIG. 10 pertaining to step S3-6 of FIG. 13.

When an estimation process instruction is issued, the management server 43 refers to the application fee charge flags of the invoice information 91-1˜91-k stored in the business partner firm database 46-i and extracts a case for which application fees have not yet been charged (step S5-1). Based on the name of the firm, the procedure and rank of the extracted case, for example, the management server 43 refers to the patent common master database 45 to obtain expense master information 81-i that is relevant to the case (step S5-2).

Then, in step S5-3, the management server 43 calculates an estimated fee based on information on the average number of claims, the average number of lines, and the average number of drawings that are contained in the expense master information 81-i obtained in step S5-2. For example, a case of using the invoice information 91-1 shown in FIG. 16 to calculate the estimated fee is described below.

First, the basic fee according to the invoice information 91-1 is 100,000 yen. Also, since the average number of claims is 4, the number of claims included in the basic fee (3) is subtracted from this number, and it is estimated that an additional claim fee for 1 claim will be charged. Thus, the estimated fee for additional claims is calculated as 1×2000=2,000 yen.

Also, since the average number of lines is 545, the number of lines included in the basic fee (200) is subtracted from this number, and it is estimated that an additional fee for 345 lines will be charged. Accordingly the estimated fee for additional lines is calculated as 345×200=69,000 yen.

Further, since the average number of drawings is 7, the number of drawings included in the basic fee (1) is subtracted from this number, and it is estimated that an additional fee for 6 drawings will be charged. Accordingly, the estimated fee for additional drawings is calculated as 6×2000=12,000 yen.

Based on the above calculations, an estimated fee of 100,000+2,000+69,000+12,000=181,000 yen is obtained.

In this way, fees may be estimated with respect to cases for which debit notes have not yet been issued, and a budget may be planned according to such estimates.

The above described estimation process may be performed on each case for which a fee is not yet charged, and the information obtained therefrom may be compiled to estimate the amount of payment that is to be made to a firm.

Also, the information that is exchanged between the terminal apparatus 111 and the management apparatus 113 is encrypted in order to secure confidentiality of the information. Alternatively, a private line may be used as the network 112, for example, to guarantee confidentiality.

It is noted that in the description of the second embodiment, the invoice, the attached documents, and the debit note are sent from the terminal apparatus 111 to the management apparatus 113 via the network 112. However, the invoice and debit note may be received as hard copies, and the copies may be converted into text data using a scanner, for example, after which the text data are referred to in conjunction with the debit note database 44, the patent common master database 45, and the business partner firm databases 46-1˜46-n to realize accuracy determination processes and estimation processes as described.

Also, it is noted that in the above description of the preferred embodiments, the present invention is described in relation to patent application filing. However, the present invention is not limited to the above embodiments, and variations and modifications may be made without departing from the scope of the present invention. For example, the present invention may be applied to interlocutory proceedings and registration of patent applications, and also various procedures for utility models, designs, and trademarks. Further, the present invention is not limited to applications in the field of intellectual property and may be applied to management of fees for general services and products as well.

The present application is based on and claims the benefit of the earlier filing date of Japanese Patent No.2002-067158 filed on Mar. 12, 2003, and Japanese Patent No.2002-070909 filed on Mar. 14, 2003, the entire contents of which are hereby incorporated by reference.

What is claimed is:

1. An intellectual property expense management system comprising:
a debit note managing unit that manages debit note information sent from a firm that is commissioned to handle application of an intellectual property right, the debit note information including expense information pertaining to the application;
a progress information managing unit that manages progress information pertaining to a progress of the application; and
an attaching unit that attaches the progress information to the debit note information.

2. The intellectual property expense management system as claimed in claim 1, further comprising an attached information managing unit that manages the attached information including the progress information attached to the debit note information.

3. The intellectual property expense management system as claimed in claim 1, wherein the attaching unit attaches the progress information to the debit note information according to a case code for identifying the application that is included in the progress information and the debit note information.

4. The intellectual property expense management system as claimed in claim 1, further comprising:
an expense information generation unit that is adapted to generate common expense information based on the debit note information, the common expense information being shared within a company that manages expense information pertaining to a plurality of applications; and
a common expense information managing unit that manages the common expense information generated by the expense generation unit.

5. The intellectual property expense management system as claimed in claim 1, further comprising a progress information updating unit that updates the progress information based on the debit note information.

6. An expense management system comprising:
a business partner terminal apparatus that is adapted to send invoice information and debit note information that is generated based on the invoice information; and
an expense management apparatus that is adapted to manage the invoice information and the debit note information sent from the business partner terminal apparatus;
wherein the expense management apparatus includes:
calculation means for calculating debit information based on the invoice information sent from the business partner terminal apparatus, thereby generating calculated debit information; and
accuracy determination means for comparing the calculated debit information obtained by the calculation means and the debit note information sent from the business partner terminal apparatus, and determining whether the debit note information sent from the business partner terminal apparatus corresponds to the calculated debit information.

7. The expense management system as claimed in claim 6, wherein the expense management apparatus includes notification means for sending a debit information verification request to the business partner terminal apparatus when it is determined by the accuracy determination means that the debit note information sent from the business partner terminal apparatus does not correspond to the calculated debit information.

8. The expense management system as claimed in claim 6, wherein the expense management apparatus includes estimation means for estimating debit information corresponding to an order for which invoice information is not yet sent from the business partner terminal apparatus, the estimation being based on a past record of the invoice information sent from the business partner terminal apparatus.

9. An expense management system comprising:
a business partner terminal apparatus that is adapted to send invoice information and debit note information that is generated based on the invoice information;
an expense management apparatus that is adapted to manage the invoice information and the debit note information sent from the business terminal apparatus; wherein
the expense management apparatus includes estimation means for estimating debit information corresponding to an order for which invoice information is not yet sent from the business partner terminal apparatus, the estimation being based on a past record of the invoice information sent from the business partner terminal apparatus.

10. An expense management apparatus comprising:
a first storage unit for storing invoice information that is sent from a business partner terminal apparatus;
a second storage unit for storing debit note information that is sent from the business partner terminal apparatus;
calculation means for calculating debit information based on the invoice information sent from the business partner terminal apparatus, thereby generating calculated debit information; and
accuracy determination means for comparing the calculated debit information obtained by the calculation means and the debit note information sent from the business partner terminal apparatus, and determining whether the debit note information sent from the business partner terminal apparatus corresponds to the calculated debit information.

11. The expense management apparatus as claimed in claim 10, further comprising notification means for sending a debit information verification request to the business partner terminal apparatus when it is determined by the accuracy determination means that the debit note information sent from the business partner terminal apparatus does not correspond to the calculated debit information.

12. The expense management apparatus as claimed in claim 10, further comprising estimation means for estimating debit information corresponding to an order for which invoice information is not yet sent from the business partner terminal apparatus, the estimation being based on a past record of the invoice information sent from the business partner terminal apparatus.

13. An expense management apparatus that receives invoice information and debit note information generated based on the invoice information from a business partner terminal apparatus, and manages the invoice information and the debit note information from the business partner terminal apparatus, the expense management apparatus comprising:
estimation means for estimating debit information corresponding to an order for which invoice information is not yet received from the business partner terminal apparatus, the estimation being based on a past record of the invoice information received from the business partner terminal apparatus.

14. An expense management method comprising:
a calculation step in which an expense management apparatus calculates debit information based on invoice information sent from a business partner terminal apparatus, thereby to generate calculated debit information; and
an accuracy determination step in which the expense management apparatus compares the calculated debit information obtained in the calculation step and debit note information generated at the business partner terminal apparatus and sent to the expense management apparatus, and determines whether the debit note information sent from the business partner terminal apparatus corresponds to the calculated debit information.

15. The expense management method as claimed in claim 14, further comprising:
a notification step in which the expense management apparatus sends a debit information verification request to the business partner terminal apparatus upon determining in the accuracy determination step that the debit note information sent from the business partner terminal apparatus is not accurate.

16. The expense management method as claimed in claim 14, further comprising:
an estimation step in which the expense management apparatus estimates debit information corresponding to an order for which invoice information is not yet sent from the business partner terminal apparatus, the estimation being based on a past record of the invoice information sent from the business partner terminal apparatus.

17. An expense management method for managing invoice information and debit note information sent from a business partner, the method comprising:
estimating debit information corresponding to an order for which invoice information is not yet sent from the business partner, the estimation being based on a past record of the invoice information sent from the business partner.
